(19) United States
(12) Patent Application Publication
(10) Pub. No.: US 2020/0291853 A1
(43) Pub. Date: Sep. 17, 2020

(54) Pulse drive

(71) Applicant: Explotechnik AG, Waltenschwil (CH)

(72) Inventors: Hans Rüegg, Waltenschwil (CH); Thomas Peterhans, Waltenschwil (CH); Manuel Sutter, Basel (CH)

(21) Appl. No.: 15/733,061

(22) PCT Filed: Nov. 5, 2018
(86) PCT No.: PCT/EP2018/080097

§ 371 Date: May 5, 2020

(30) Foreign Application Priority Data
Nov. 6, 2017 (CH) 01330/17

(51) Int. Cl. F02C 5/00; F23R 7/00

(52) U.S. Cl. CPC F02C 5/00; F23R 7/00

(57) ABSTRACT

A device serves for the repeated generation of explosions, in particular for the drive of an aircraft. It comprises: ▪a combustion chamber (21), ▪at least one feed line for feeding a flowable, explosive material or components which form an explosive material upon mixing to the combustion chamber (21); ▪a discharge device for the targeted discharge of a gas pressure which is generated by way of ignition of the explosive material in the combustion chamber (21), ▪a movable nozzle regulating element (26) for the partial or complete closure of the discharge device, ▪an actuating element (25) which is configured to open the discharge device further after opening of the discharge device and during an outflow of explosion gases by way of the discharge device. Here, the discharge device has a plurality of part nozzles (40) for the discharge of the gas pressure, and a position of the part nozzles (40) can be set by way of the actuating element (25).

The invention relates to a device and to a method for the repeated generation of explosions for energy conversion, for example for the generation of thrust, in particular in aircraft.

Propulsion engines, so-called pulse detonation engines (PDE) are known, concerning which engines instead of a continuous combustion at constant pressure, the temperature and pressure increase of isochoric combustion at a constant volume, i.e. by way of explosions is utilised. In contrast to the internal combustion engine, in which the produced pressure drives the piston in a direct manner, a maximisation of the kinetic energy of the outflowing combustion gases is desired. Hence the combustion gases which are produced with the explosion are to be accelerated to the maximum speed for producing maximal thrust and are to be applied for propulsion purposes. The Holzwarth turbine for generating electricity as well as pulsed jet engines which produced thrust at a high frequency by way of explosions have become known.

A method for generating pressure impulses by way of explosions is described in the European patent application EP 2 319 036 A2 (and likewise US 2011/180020 A1). Herein, a mixture of oxidant and combustible is ignited in a container which is closed by a valve and an explosion is produced. The valve is opened shortly before the ignition and the pressure wave of the explosion can be led to its designated location via the outlet opening. The device, also called explosion generator (EG) is applied nowadays for cleaning contaminated steam boilers.

A pulse detonation drive is disclosed in the European patent application EP 3 146 270 A1 (and likewise US 2017/082069 A1), said pulse detonation drive comprising an actuating device which given an outflow of explosion gases through an exit nozzle adjusts an area ratio between the nozzle inlet area and the nozzle outlet area, said ratio at least approximately following an ideal area ratio for producing a maximal exit speed of the explosion gases in dependence on the pressure in the explosion space.

One possible object of the invention is to provide a device and a method of the initially mentioned type which effect an improved conversion of the energy which is released given the explosion, into kinetic energy of the combusted gas.

This object is achieved by a device and a method with the features of the respective independent patent claims.

The device serves for the repeated generation of explosions and for converting chemical energy into kinetic energy of outflowing exhaust gases of the explosions, in particular for generating thrust for the propulsion of an aircraft. It comprises:
a combustion chamber as an explosion space,
at least one feed conduit for feeding a flowable, explosive material or of components which on mixing form an explosive material, to the combustion chamber;
a discharge device for the directed discharge of a gas pressure which is produced in the combustion chamber by the ignition of the explosive material,
a movable nozzle regulation element as a closure element for the partial or complete closure of the discharge device;
an actuating element which is designed to open the discharge device further (successive) after an opening of the discharge device and during the outflow of explosion gases through the discharge device.

Herein, the discharge device comprises several part-nozzles for discharging the gas pressure, and a position of the part-nozzles can be adjusted by the actuating element.

The part-nozzles each correspond to separate openings of the discharge device. In principle, the individual openings are individually closable, but in an embodiment can be commonly activated and commonly closed.

Given the same travel of the actuating element, a larger cross-sectional area can be released on using several individual small part-nozzles than on using only one nozzle with only one nozzle opening. This means that given only one large nozzle, the actuating element needs to be opened significantly further in order to release the same cross-sectional area. This means that the speed of the actuating element must be higher, in order to achieve the same increase of the cross-sectional area per unit of time. In practice, the maximal speed of the actuating element is a critical, limiting variable. For this reason, it can be advantageous if the necessary speed of the actuating element is kept as low as possible and the area which is herein released is kept to a maximum as much as possible.

Herewith, in embodiments, a nozzle, in particular a convergent-divergent nozzle is realised by the sum of the part-nozzles, and this nozzle ensures that the optimal, ideal area ratio between the nozzle end (nozzle outlet area) and nozzle neck (nozzle inlet area) is always at least approximately adjusted to during the complete outflow time. By way of this, the outflow speed of the exhaust gases (combusted gases) of the device, or their kinetic energy can ideally be at least approximately maximised. The outflow speed preferably exceeds the speed of sound. If the device or the vehicle is directly driven/propelled by the exhaust gases, then a thrust which affects the propulsion results in accordance with the outflow speed. Herein, the thrust can be maximised in accordance with the inner pressure by way of the respective opening width of the discharge device. If a turbine is driven by the exhaust gases, then only a part of the kinetic energy of the exhaust gases is used for this. Depending on the design and setting/adjustment of this turbine, a remaining part of the kinetic energy at the outlet of the turbine can be used in a direct manner for driving/propelling the device or a vehicle.

As a whole, a high efficiency can be realised by the device on converting chemical energy into mechanical energy or work. Chemical energy is defined as the energy form which is stored in an energy carrier in the form of a chemical compound and can be released given chemical reactions.

In contrast to the known pulse detonation drive of the European patent application EP 3 146 270 A1 (or US 2017/082069 A1), the speed at which the cross-sectional area of the entirety of all nozzles is changed can be increased.

In embodiments, each of the part-nozzles comprises a part valve seat and a part valve body, and a part nozzle inlet area is determined by the position of the part valve body in relation to the part valve seat. Herein, the nozzle regulation element determines the positions of the part valve bodies in relation to the part valve seats.

Herein, a part-nozzle can be closable by way of the movement of the respective part valve body towards the respective part valve seat. The sum of the part nozzle inlet areas forms a total nozzle inlet area, and the sum of the part nozzle outlet areas forms a total nozzle outlet area.

In embodiments, the part valve bodies are each part of a valve body. A movement of the valve body therefore effects a movement of the part valve bodies with one another, in particular a movement of the part valve bodies towards the part valve seats or away from these. In embodiments, the part-valve seats are each formed on a common valve seat body.

In embodiments, openings of the part-nozzles comprise annular openings which are arranged concentrically to one another.

In embodiments, the openings of the part-valves each comprise separate circular openings. The openings can all have the same size or the same diameter, or can have different diameters. In embodiments, the openings of the part-valves each comprise separate linear openings.

In embodiments, a part-nozzle each comprises a part valve body in the form of a regulation valve needle, and a part nozzle inlet area of the part-nozzle is determined by the position of the regulation valve needle with respect to the part valve seat.

In embodiments, the regulation valve needles each have an outer contour which tapers towards a valve tip, in particular an at least approximately cone-shaped outer contour. In embodiments, the part valve seat and the part valve body form a convergent-divergent part of the respective part-nozzle.

A flowable, explosive substance or a flowable explosive mixture which is formed by way of mixing components which preferably per se are not explosive is introduced into the combustion chamber. The flowable substances and/or substance mixtures are for example gaseous, fluid, powder-like, dust-like or pulverous or a mixture of such component substances. Typically, one component is a combustible and another component is an oxidiser. For example, a mixture consist of two gases under pressure. Here and hereinafter, all variants and possible combinations of substances and mixtures are simply called “flowable, explosive material”, without this being understood as a restriction to a single substance or to a certain mixture.

Given isochoric combustion at a constant volume, greater combustion temperatures are achieved than given combustion at a constant pressure. In the case of an explosive combustion, an enormous pressure increase is additionally achieved. E.g. given a stoichiometric combustion of air and natural gas at a constant volume, a pressure increase by the factor 7.5 can be achieved, i.e. given a preliminary pressure of 10 bar of the mixture, the peak pressure in the explosion space is approx. 75 bar. With such applications with an isochoric combustion, the aim is to produce a gas jet which leaves the explosion space at maximal speed.

In embodiments, the device its provided for use with a preliminary pressure which is provided between ambient pressure and twenty-fold the ambient pressure, for example between six-fold and twelve-fold the ambient pressure.

In embodiments, the combustion chamber has a changeable volume.

respect to a maximal volume. Given a reduced combustion chamber volume, the combusted mixture flows out more rapidly compared to the maximal volume. The shortened outflow duration leads to the thrust being present for a shorter time duration. Herewith, the average thrust of the device over several pulses reduces. The reduced volume simultaneously leads to a smaller quantity of explosive mixture per pulse and also in the temporal average.

In embodiments, the device comprises a displaceably arranged separating wall which forms a delimitation of the combustion chamber.

By way of this, the variation of the volume of the combustion chamber can be realised in a mechanically simple manner.

In embodiments, the separating wall forms a delimitation of the combustion chamber which lies opposite the discharge device. In particular, the actuating element can be led through the separating wall.

By way of this, the variation of the volume of the combustion chamber can be realised in a space-saving manner and a rotationally symmetrical shape of the combustion chamber can be retained independently of the position of the separating wall.

In embodiments, the actuating element comprises a drive means for the drive of an opening movement of the discharge device, in particular by way of the drive means being realised by way of an auxiliary explosion device, in which an auxiliary explosion produces a force which assists the opening movement.

Details concerning the drive of such an auxiliary explosion device are described in the initially mentioned EP 2319036A2. In particular, according to an embodiment, it is possible to synchronise the explosion in the auxiliary explosion device with that in the explosion space by way of a conduit, also called delay conduit.

A further force or force component which assists in the opening movement can arise by way of the recoil of the outflowing explosion gases against the actuating element.

In an embodiment, the actuating element is configured to temporally completely close the discharge device. Herewith, it is possible to increase the pressure in the explosion space to above ambient pressure before the ignition.

In embodiments, the device comprises a compressing device for compressing the flowable explosive material or at least one of the components of the explosive material. By way of this, the pressure of the explosive material can be increased with respect to the ambient pressure before the ignition. The pressure which is produced by the explosion is a function of this pressure before the ignition and is herewith also increased accordingly. Herewith, the thrust which is produced by the device can also be increased.

In embodiments, the compressing device is a continuously operated compressor, in particular a rotating compressor, for example a turbo-compressor.

The compressor can be a rotating compressor, in particular a turbo-compressor.

In embodiments, the compressor is driven by a turbine, and the turbine is arranged to be driven by an exhaust gas jet from a turbine combustion chamber, wherein the turbine combustion chamber is different to the combustion chamber.

In other words, the compressor, the turbine and the turbine combustion chamber are herein parts of a gas turbine. The gas turbine is used in order to operate the compressor. The turbine or the turbine combustion chamber can be operated with the same combustible as with the combustion chamber. The explosive material can therefore be the same mixture as in the combustion chamber, but be in a different mixing ratio.

In embodiments, the compressor is driven by a turbine, and the turbine is arranged to be driven by exhaust gases of the combustion chamber.

In contrast to the topology with a separate gas turbine, here therefore it is the flow of the exhaust gases of the PE which are utilised for the drive of the compressor. This simplifies the device and, thanks to the generally better efficiency of the PE in comparison to a conventional gas turbine, increases the total efficiency of the device.

In embodiments, the device comprises an output for delivering mechanical work to a mechanical consumer.

In embodiments, the device comprises an output for delivering mechanical work to a flow machine. This can be a propeller, for the propulsion of a vehicle, in particular of an aircraft.

In embodiments, the device comprises an output for delivering mechanical work to a generator. Herewith, the mechanical work is converted into electrical energy.

In embodiments, the device comprises a compression device in the form of an air inlet, for compressing inflowing air given supersonic speed of the device in relation to the ambient air.

Such a compression device can be present alternatively or additionally to a compressor.

Herewith, it is particular in the case of an aircraft that the compression in a compressor can be replaced by the compression in the air inlet on reaching supersonic speed.

In embodiments, the discharge device is configured, given an outflow of explosion gases through the discharge device, to adjust an area ratio between a total nozzle inlet area and a total nozzle outlet area of the discharge device, said ratio at least approximately following an ideal area ratio for producing a maximal outlet speed of the explosion gases in dependence on the pressure in the combustion chamber.

This can be realised by way of the nozzle regulation element being arranged for the variation of a total nozzle inlet area which is the sum of the part nozzle inlet areas. Herein, the actuating elements can be configured to control a movement of the nozzle regulation element for adjusting the total nozzle inlet area at least approximately in accordance with the mentioned ideal area ratio.

In embodiments, the actuating device comprises a drive means for the drive of an opening movement of the nozzle regulation element, in particular by way of the drive means being realised by way of an auxiliary explosion device with an auxiliary combustion chamber, in which an auxiliary explosion produces a force which assists in the opening movement.

In embodiments, the actuating device comprises a braking means for delaying an opening movement of the regulation valve, in particular by way of the braking means being realised by a gas compression spring or by a camshaft or by a gas compression spring in combination with a camshaft.

In embodiments, the nozzle regulation element is configured to temporarily completely close the discharge opening.

The method for the repeated generation of explosions and for converting chemical energy into kinetic energy of outflowing exhaust gases of the explosions, in particular for producing thrust for the propulsion of an aircraft, comprises the repeated execution of the following steps:
feeding a flowable, explosive material or of components which on mixing form the explosive material, into a combustion chamber, wherein a discharge device of the combustion chamber is closed at least partly by way of a movable nozzle regulation element, and generating, in relation to an ambient pressure, an overpressure in the combustion chamber;
opening the discharge device;
igniting the explosive material in the combustion chamber;
leading away explosion gases through the discharge device:
at least partial closure of the discharge device by way of the movable nozzle regulation element.

### Herein:

for opening the discharge device and on leading away explosion gases, several part-nozzles are opened synchronously to one another, and
for the at least partial closure of the discharge device, several part-nozzles are at least partly closed synchronously to one another.

In embodiments, the part-steps “opening the discharge device”, “igniting the explosive material in the combustion chamber” and “leading away explosion gases through the discharge device by way of the movable nozzle regulation element” are carried out in a temporally overlapping manner.

In embodiments, the part-nozzles each comprise part valve seats and part valve bodies, and the part valve bodies are moved synchronously to one another in relation to the part valve seats by way of the nozzle regulation element.

Further preferred embodiments are to be derived from the dependent patent claims. Herein, the features of the method claims where appropriate can be combined with the device claims and vice versa.

The subject-matter of the invention is hereinafter explained in more detail by way of preferred embodiment examples which are represented in the accompanying drawings. Shown schematically are:

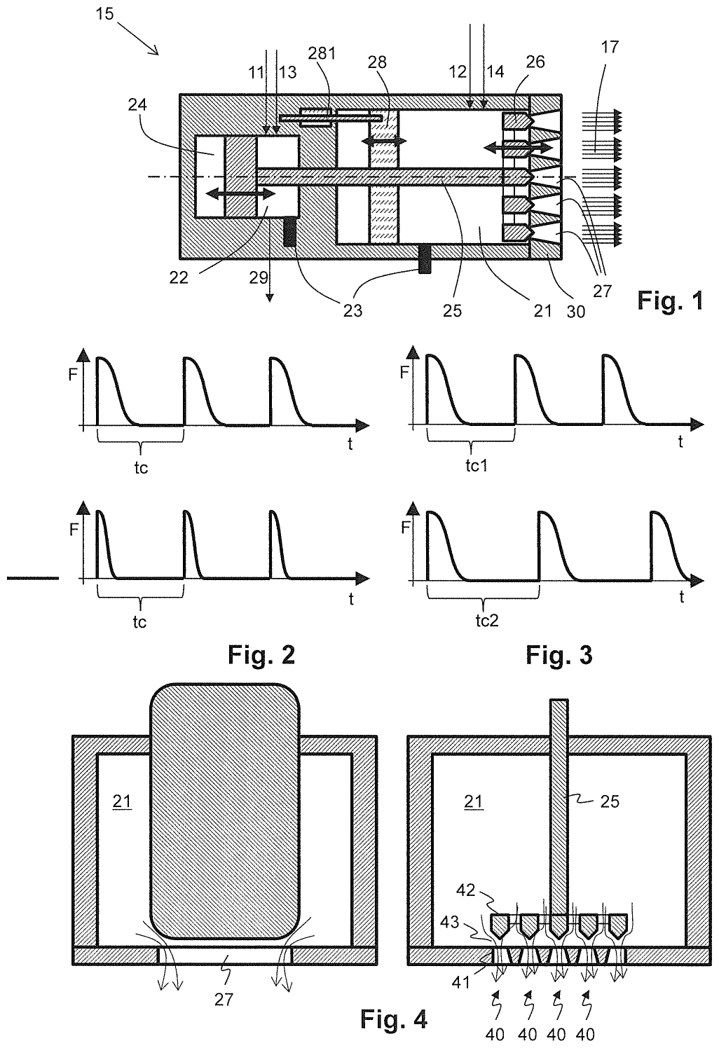

FIG. 1 a pulse drive machine or pulse engine (PE);

FIG. 2 an operating mode of the PE with the variable volume of its combustion chamber;

FIG. 3 an operating mode with a variable frequency;

FIG. 4 increase of an opening speed by way of the use of several part-nozzles with individual nozzle openings;

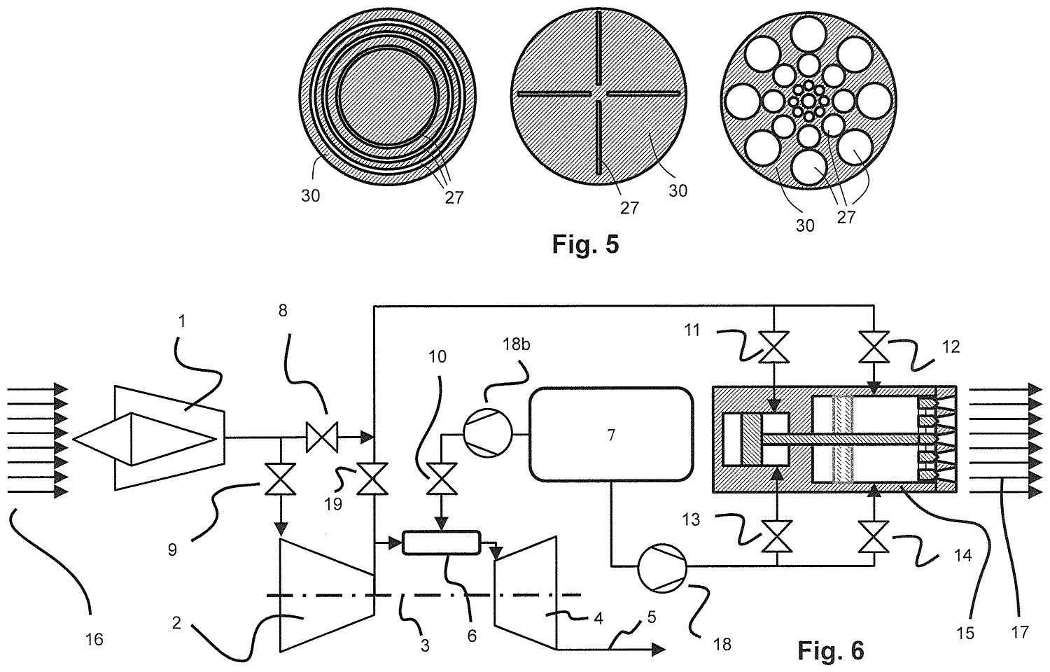

FIG. 5 different nozzle bodies each with several nozzle openings;

FIG. 6 a PE with a charging by way of a separate gas turbine;

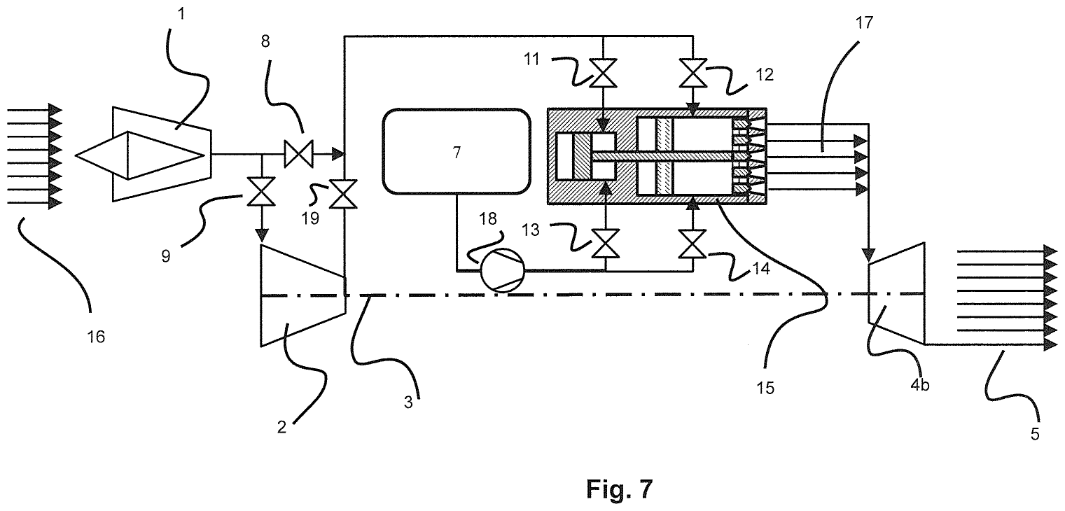

FIG. 7 a PE with a charging by way of a turbine which is driven by exhaust gases of the PE;

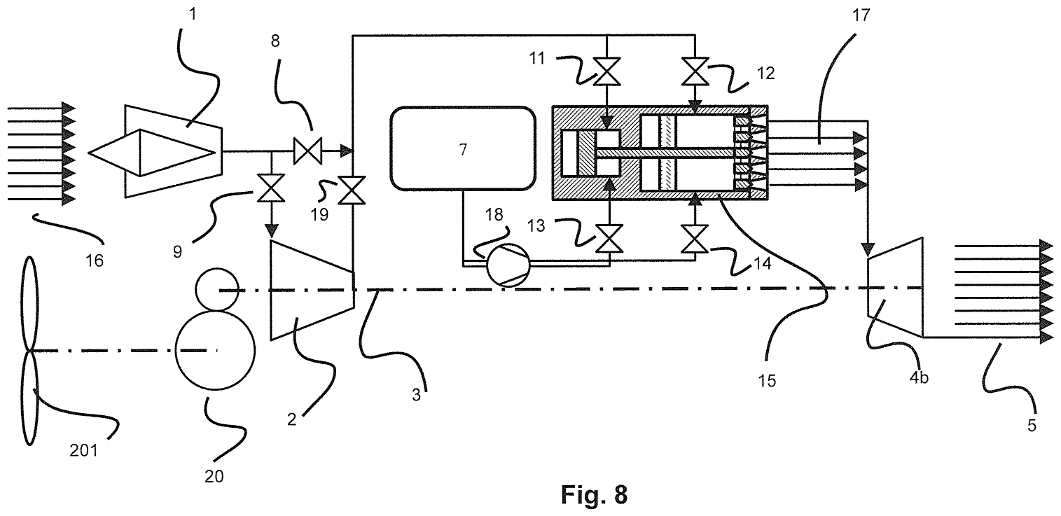

FIG. 8 a PE with a propeller which is driven by the turbine; and

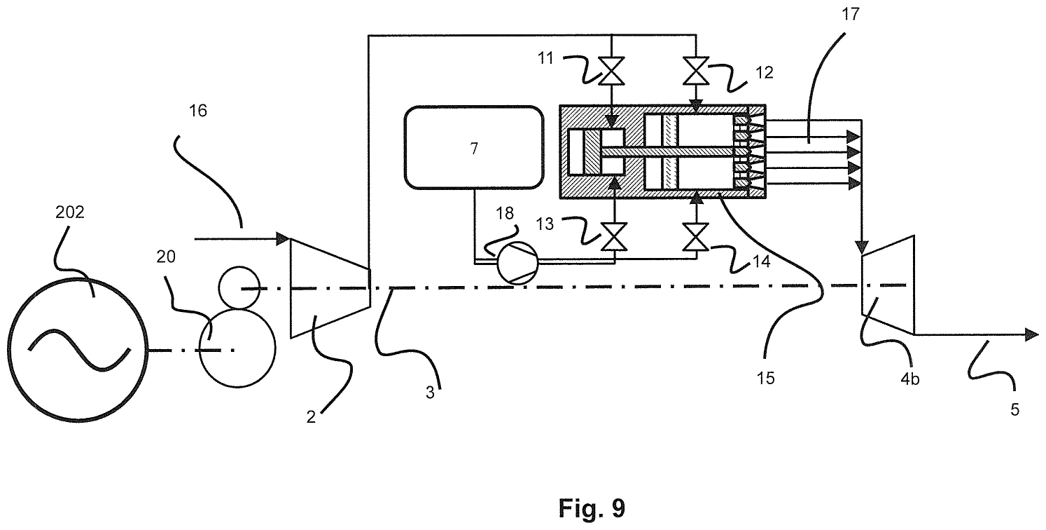

FIG. 9 a PE with a generator which is driven by the turbine.

Basically in the figures, the same or equally acting parts are provided with the same reference numerals.

FIG. 1 shows a device for the repeated generation of explosions, hereinafter also called pulse engine or PE 15. A combustion chamber 21 or explosion space can be filled with a flowable, explosive material, for example an explosive gas mixture, via a filling device. For this, the filling device comprises a combustion chamber air inlet 12 for the feed of an oxidant, for example air, and a combustion chamber combustible inlet 14 for the feed of a combustible or fuel, for example hydrogen. The flowable explosive material which is formed therefrom can be ignited and brought to explode by an ignition device, for example by a spark plug 23.

An outlet of the combustion chamber 21 for exhaust gases 17 leads through nozzle openings 27. The nozzle openings 27 are closable by way of nozzle regulation elements 26 of an actuating element 24. In a neutral position, the nozzle opening 27 is closed by the actuating element 25. The actuating element 25 is herein held in this position by way of a gas spring 24.

The nozzle regulation element 26 seals the combustion chamber 21 towards the nozzle openings 27 during the filling of the combustion chamber 21. By way of this, a preliminary pressure with an overpressure can be produced, with which overpressure in turn a greater explosion pressure can be produced.

An auxiliary combustion chamber 22 is likewise fillable with an explosive material via a further filling device with an auxiliary combustion chamber air inlet 11 and with an auxiliary combustion chamber combustible inlet 13. The actuating element 25 is movable counter to the pressure of the gas spring 24 by means of an explosion in the auxiliary combustion chamber 22 and the nozzle opening 27 can be opened by way of this.

On operation of the PE 15, the auxiliary combustion chamber 22 and the combustion chamber 21 can each be filled with the same explosive material. Basically, different materials or different mixtures can also be applied in both combustion chambers. Firstly, the explosive material is ignited in the auxiliary combustion chamber 22 by way of an assigned spark plug 23.

By way of this, the pressure in the auxiliary combustion chamber 22 increases and the actuating element 25 begins to move and hence begins to release the nozzle opening 27 of the combustion chamber 21. The explosive material is subsequently ignited in the combustion chamber 21, for example by a further spark plug 23.

The spark plugs 23 of the auxiliary combustion chamber 22 and of the combustion chamber 21 are therefore ignited shortly after one another. A delay between the two ignition points in time can be selected such that an exit speed of the exhaust gases 17 or a total energy which is converted into kinetic energy of the exhaust gases 17 is maximised.

In another embodiment, the material in the combustion chamber 21, via a conduit or delay conduit, likewise filled with explosive material, is ignited by way of an explosion which comes from an auxiliary combustion chamber 22 and is led through the delay conduit.

The filling of the combustion chambers (combustion chamber 21 and auxiliary combustion chamber 22) can be effected in stages and in the following sequence, firstly the oxidant through the combustion chamber air inlet 12 or the auxiliary combustion chamber air inlet 11, then the combustible through the combustion chamber combustible inlet 14 or the auxiliary combustion chamber combustible inlet 3. Herewith, the respective combustion chamber wall can be cooled with the oxidant during the filling, without a mixture being able to ignite on the combustion chamber wall. The cooling possibility which is created on account of this permits the maximisation of the cycle frequency. Herewith, the power density, thus the maximal thrust per combustion chamber volume can be maximised.

Regarding further elements of the design and method aspects for the operation of the device, the initially mentioned EP 3 146 270 A1 is referred to, whose contents are herewith incorporated into the present application.

The combustion chamber 21 comprises a separating wall 28 which forms a section of the entirety of the walls of the combustion chamber 21. The volume of the combustion chamber 21 is changeable by way of displacing the separating wall 28. The separating wall 28 can be displaced by way of a schematically represented adjusting device 281 and the volume can be varied herewith. In FIG. 1, the separating wall 28 by way of example is movable in the same direction, along which the actuating element 25 is moved to and fro.

FIG. 2 illustrates an operating mode of the PE 15 with a variable volume in its combustion chamber, each with a temporal course of a thrust F which is produced by the PE 15: in the upper course with a larger and in the lower course with a smaller volume of the combustion chamber, but with a constant pulse period tc. Given a reduced combustion chamber volume, the combusted mixture flows out more rapidly in comparison to the larger volume. The shortened outflow duration leads to the thrust prevailing for a shorter time duration. The average thrust of the PE 15 over time therefore reduces. The consumption of combustible and oxidiser per pulse as well as its temporal average also reduces due to the lower volume.

FIG. 3 shows an operating mode of the PE 15 with a variable frequency, in the upper course with a greater operating frequency (or smaller pulse period tc1) and in the lower course with a smaller operating frequency (or larger pulse period tc2). Herein, it is merely the number of thrust pulses per unit of time which is reduced, whilst the pulse per se is kept the same, i.e. with the same volume. By way of this, the thrust and the consumption in the temporal average also become smaller.

On operation, the volume as well as the operating frequency can be varied. Herewith, the same average thrust can be achieved with different combinations volumes and operating frequency, and the operation optimised. For example, the stoichiometry of the mixture can be varied herewith. For example, rapid load changes can be effected by way of adapting the operating frequency and subsequently given a constant load by way of the slow adaption of the volume given a simultaneously compensation by the operating frequency. Given an optimisation, one can take into account the fact that with a thrust regulation over the operating frequency, the individual pulses can all be of a certain optimised temporal course or pulse type. Concerning thermal losses, a large volume is more advantageous compared to a small volume with regard to the ratio of the surface to volume. Given a drive of an exhaust gas turbine, an additional degree of freedom is present with the selection of the operating state: depending on how the efficiency of the exhaust gas turbine behaves as a function of PE frequency and PE volume, it can be advantageous if the PE volume can be reduced in the part-load region.

FIG. 4 shows an increase of an opening speed by way of using several part-nozzles with individual nozzle openings. A nozzle with an individual nozzle opening 27 is shown on the left and a nozzle with several part-nozzles 40 is shown on the right. Each of the part-nozzles 40 comprises a part valve seat 41 and a part valve body 42. The part valve body 42 can bear on the part valve seat 41 and thus close the part-nozzle 40, and can be moved away from the part valve seat 41 for opening the part-nozzle 40. The part valve bodies 42 can be moved commonly, i.e. synchronously, by the actuating element 25, for example by way of the part valve bodies 42 being formed on the same body, or all being fastened to one another in a rigid manner on the actuating element 25 or on a common actuating device. On moving the part valve body 42 away from the part valve seats 41, given the same travel of the valve bodies or of the actuating element 25, a larger cross-sectional area is released than on using only one nozzle. Herewith, a temporal change of a total cross-sectional area of all part nozzles 40 is greater than on using only one single nozzle. Hence by way of the nozzle opening 27 consisting of several individual part-nozzles, the speed at which the nozzle opening 27 is opened and a larger cross-sectional area is released can be increased without the actuating element 25 having to be moved more rapidly.

The several part-nozzles 40 or the nozzle openings 27 can be shaped differently. FIG. 5 shows different nozzle bodies 30 each with several nozzle openings 27, arranged as concentric rings, radial linear jets and as circular openings with different diameters. In other embodiments, the circular openings all have the same diameter (not represented).

FIG. 6 shows a PE 15 with a charging by a separate gas turbine. Herein, fuel or combustible is transported from a combustible tank 7 via a fuel delivery device 18 and via fuel inlet valves (auxiliary combustion chamber combustible inlet 13 and combustion chamber combustible inlet 14) to the combustion chamber 21 and to the auxiliary combustion chamber 22 of the PE 15. A further fuel delivery device 18b delivers the fuel via a turbine combustion chamber feed valve 10 to a turbine combustion chamber 6 which is operated in a continuous (thus non-pulsating manner) and via a turbine 4 and shaft 3 drives a compressor 2. This compressor 2 is fed by air from an air inlet 1, compresses the air and leads it via the air inlet valves (auxiliary combustion chamber air inlet 11 and combustion chamber air inlet 12) into the combustion chambers 21, 22.

The compressor 2 can be a radial compressor or axial compressor as well be of one or more stages. The turbine 4 and the further turbine 4b can be one-stage or multi-stage. The air can already be pre-compressed in the air inlet 1 by way of ram pressure compressing. The higher the mach number of the inflowing air 16, the greater is this (pre) compressing. Since the air is already adequately compressed in the air inlet 1 given sufficiently high mach numbers, the compressor 2 becomes superfluous at these mach numbers. At mach numbers, at which the compressor 2 is required, a bypass valve 8 is closed and a compressor inlet valve 9 is open. If the compressor is no longer used due to the high speed of the inflowing air 16, then the compressor inlet valve 9 is closed and the bypass valve 8 is opened. By way of this, the compressor 2 is bridged. In this case a compressor outlet valve 19 is also closed.

A vehicle, in particular an aircraft can be propelled by the outflowing exhaust gases 17 of the PE 15 or by the thrust which is produced by way of this.

FIG. 7 shows a PE 15 with a charging by way of a further turbine 4b which is driven by exhaust gases 17 of the PE 15 via a common shaft 3. Instead of being driven by a separate gas turbine as an auxiliary assembly, the compressor 2 can also be driven via a turbine 4b which is driven by the exhaust gases 17 from the PE 15. In this case, one can forego the further fuel delivery device 18b as well as the turbine combustion chamber 6.

FIG. 8 shows a PE 15, in which the further turbine 4b which is driven by the exhaust gases 17 of the PE 15 drive a propeller or airscrew 201, in particular via a step-down gear 20. This propeller can be of a shrouded or a non-shrouded design. The propeller serves for the propulsion of a vehicle, in particular an aircraft, as with a turboprop. An exhaust gas jet 5 of the further turbine 4b can likewise contribute to the propulsion.

FIG. 9 shows a PE 15, in which the further turbine 4b which is driven by the exhaust gases 17 of the PE 15 drives a generator 202. When necessary, a step-down gear 20 can be arranged between the shaft 3 and the generator 202.

1-15. (canceled)

16. A device for the repeated generation of explosions and for converting chemical energy into kinetic energy of outflowing exhaust gases of the explosions, in particular for generating thrust for the propulsion of an aircraft, comprising:
a combustion chamber (21),
at least one feed conduit for feeding a flowable, explosive material or of components which on mixing form an explosive material, to the combustion chamber (21);
a discharge device for the directed discharge of a gas pressure which is produced in the combustion chamber (21) by the ignition of the explosive material,
a movable nozzle regulation element (26) for the partial or complete closure of the discharge device;
an actuating element (25) which is designed to open the discharge device further after an opening of the discharge device and during the outflow of explosion gases through the discharge device,
characterised in that the discharge device comprises several part-nozzles (40) for discharging the gas pressure, and a position of the part-nozzles (40) is adjustable by the actuating element (25).

17. The device according to claim 16, wherein each of the part-nozzles (40) comprises a part valve seat (41) and a part valve body (42), and a part nozzle inlet area (43) is determined by the position of the part valve body (42) in relation to the part valve seat (41), and wherein the nozzle regulation element (26) determines the positions of the part valve bodies (42) in relation to the part valve seats (41).

18. The device according to claim 16, wherein openings of the part-nozzles (40) comprise annular openings which are arranged concentrically to one another.

19. The device according to claim 16, wherein the combustion chamber (21) has a changeable volume.

20. The device according to claim 19, comprising a displaceably arranged separating wall (28) which forms a delimitation of the combustion chamber (21).

21. The device according to claim 20, in which the separating wall (28) forms a delimitation of the combustion chamber (21) which lies opposite the discharge device, and in particular the actuating element (25) is led through the separating wall (28).

22. The device according to claim 16, comprising a compressing device (1, 2) for compressing the flowable explosive material or at least one of the components of the explosive material.

23. The device according to claim 22, wherein the compressing device is a continuously operated compressor (2), in particular a rotating compressor, for example a turbo-compressor.

24. The device according to claim 23, wherein the compressor (2) is driven by a turbine (4), and the turbine (4) is arranged to be driven by an exhaust gas jet (5) from a turbine combustion chamber (6), wherein the turbine combustion chamber (6) is different to the combustion chamber (21).

25. The device according to claim 23, wherein the compressor (2) is driven by a turbine (4), and the turbine (4) is arranged to be driven by exhaust gases (17) of the combustion chamber (21).

26. The device according to claim 25, comprising an output for delivering mechanical work to a mechanical consumer, in particular to at least one of:
a flow machine, in particular a propeller, for the propulsion of a vehicle, in particular of an aircraft, and
a generator for conversion into electrical energy.

27. The device according to claim 22, comprising a compression device in the form of an air inlet (1), for compressing inflowing air given supersonic speed of the device in relation to the ambient air.

28. A method for repeated generation of explosions and for converting chemical energy into kinetic energy of outflowing exhaust gases of the explosions, in particular for producing thrust for the propulsion of an aircraft, the method comprising the repeated execution of the following steps:
feeding a flowable, explosive material or components which on mixing form the explosive material, into a combustion chamber (21), wherein a discharge device of the combustion chamber (21) is closed at least partly by way of a movable nozzle regulation element (26), and generating, in relation to an ambient pressure, an overpressure in the combustion chamber (21);
opening the discharge device;
igniting the explosive material in the combustion chamber (21);
leading away explosion gases through the discharge device; and
at least partial closure of the discharge device by way of the movable nozzle regulation element (26);
characterised in that:
for opening the discharge device and on leading away explosion gases, several part-nozzles (40) are opened synchronously to one another; and
for the at least partial closure of the discharge device, several part-nozzles (40) are at least partly closed synchronously to one another.

29. The method according to claim 28, wherein the part-steps “opening the discharge device”, “igniting the explosive material in the combustion chamber” and “leading away explosion gases through the discharge device by way of the movable nozzle regulation element” are carried out in a temporally overlapping manner.

30. The method according to claim 28, wherein the part-nozzles (40) each comprise part valve seats (41) and part valve bodies (42), and the part valve bodies (42) are moved synchronously to one another in relation to the part valve seats (41) by way of the nozzle regulation element (26).
